(19) United States
(12) Patent Application Publication
(10) Pub. No.: US 2013/0329527 A1
(43) Pub. Date: Dec. 12, 2013

(54) LOCATION AWARE REMINDERS

(71) Applicants: Kasthuri Alavala, Redmond, WA (US); Shivani S. Caplan, Bellevue, WA (US); Smitha Vuppuluri Gonugunta, Sunnyvale, CA (US); Narasimha S. Kanakala, Redmond, WA (US); Yu Zhang, Redmond, WA (US)

(72) Inventors: Kasthuri Alavala, Redmond, WA (US); Shivani S. Caplan, Bellevue, WA (US); Smitha Vuppuluri Gonugunta, Sunnyvale, CA (US); Narasimha S. Kanakala, Redmond, WA (US); Yu Zhang, Redmond, WA (US)

(73) Assignee: MICROSOFT CORPORATION, Redmond, WA (US)

(21) Appl. No.: 13/492,079

(22) Filed: Jun. 8, 2012

(51) Int. Cl. G04B 47/00

(52) U.S. Cl. 368/10

(57) ABSTRACT

Location aware reminder techniques are described. In one or more implementations, an amount of time is determined by a computing device that is likely to be involved for a user to access a scheduled event. A point in time at which to output a reminder by the computing device before the scheduled event is computed based at least in part on the determined amount of time that is likely to be involved for the user to access the scheduled event.

### BACKGROUND

A variety of different scheduling functionality is made available to users. One example of such functionality is a calendar that may be used to keep track of events as well as invite other users to participate in the events, such as through communication of a meeting request via a network. This scheduling functionality has become a part of everyday life for a wide variety of users for both business and personal uses.

However, conventional techniques that were utilized to schedule events typically involved a reminder that was set by the event's organizer. Although a user was provided with an option to change the reminder duration, this may involve a significant series of steps to manually access the calendar event and change the duration. Further, this duration was often set as a “best guess” on the part of the user regarding how much notice is desirable, which could change for a variety of subsequent reasons which would again involve this manual interaction.

### SUMMARY

Location aware reminder techniques are described. In one or more implementations, an amount of time is determined by a computing device that is likely to be involved for a user to access a scheduled event. A point in time at which to output a reminder by the computing device before the scheduled event is computed based at least in part on the determined amount of time that is likely to be involved for the user to access the scheduled event.

In one or more implementations, a point in time is determined at which to display a reminder, by a computing device, based at least in part on a likely travel time to physically travel to a geographic location of a destination that is a subject of the reminder. The reminder is then output at the determined point in time by the computing device.

In one or more implementations, a determination is made as to likely travel time of a user to a geographic location associated with a scheduled event. At least the determined likely travel time is used to indicate that a corresponding amount of time is unavailable before the scheduled event for scheduling another event using a schedule of the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ location aware reminder techniques described herein.

FIG. 2 depicts a system in an example implementation in which a diagram that includes a scheduler module of FIG. 1 is shown.

FIG. 3 depicts a sequence diagram showing an example of determination of a point in time at which to output a reminder.

FIG. 4 depicts an example of a workflow that is used to output different reminders for different users that are to access a scheduled event.

FIG. 5 depicts a system that is configured to employ a scheduler module to address how a user is to access a scheduled event.

FIG. 6 depicts an example of a user interface usable to schedule an event.

FIG. 7 depicts an example of a user interface usable to schedule whether to use travel time as part of a reminder for the event of FIG. 6.

FIG. 8 is a flow diagram depicting a procedure in an example implementation in which a point at time at which to output a reminder is determined based on user access.

FIG. 9 is a flow diagram depicting a procedure in an example implementation in which a point at time at which to display a reminder is determined at least in part on a travel time to a geographic location.

FIG. 10 is a flow diagram depicting a procedure in an example implementation in which an amount of time that is likely to be used to travel to a scheduled event is indicated as unavailable on a user's calendar.

FIG. 11 illustrates an example system including various components of an example device that can be implemented as any type of computing device as described with reference to FIGS. 1-7 to implement embodiments of the techniques described herein.

### DETAILED DESCRIPTION

Overview

Reminders for scheduled events are typically static and set by the organizer of the event. Consequently, the reminder may not serve to adequately notify a user, especially in instances in which other users have access to the user's schedule.

Location aware reminder techniques are described. In one or more implementations, techniques are described in which an amount of time that is to be used to display a reminder before a scheduled event is determined based on a likely amount of time that it will take a user to access the scheduled event. A user, for instance, may be scheduled to access the event via a telephone, and therefore the reminder may be set for output to give a relatively small amount of notice, e.g., three minutes before the event.

In another instance, the user may be scheduled to attend the event in person. In this instance, a likely travel time may be computed for the user to travel to the event. This travel time may then be used, at least in part, in determining a point in time at which to output the reminder. In this way, the reminder may be dynamically configured to give the user sufficient notice to attend the event.

The amount of time may be calculated to also address a variety of other factors, such as a distance, a mode of travel (e.g., motorized versus un-motorized), potential delays (e.g., traffic, accidents), weather, a change in a location of the scheduled event, a likely location of a user before the event (e.g., GPS, location of a previous scheduled event), and so forth. This amount of time may also be leveraged to provide a variety of other functionality, such as to automatically indicate that the user is unavailable during this time to attend another scheduled event. Further discussion of these and other features may be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

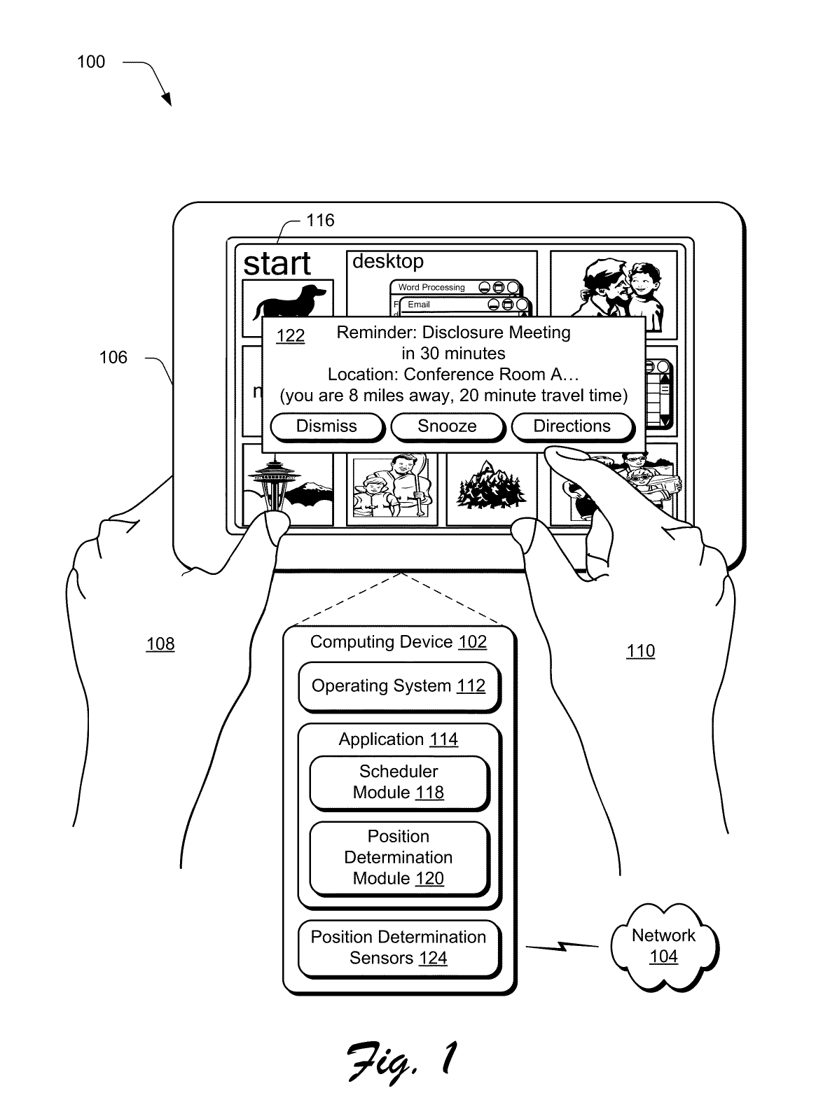

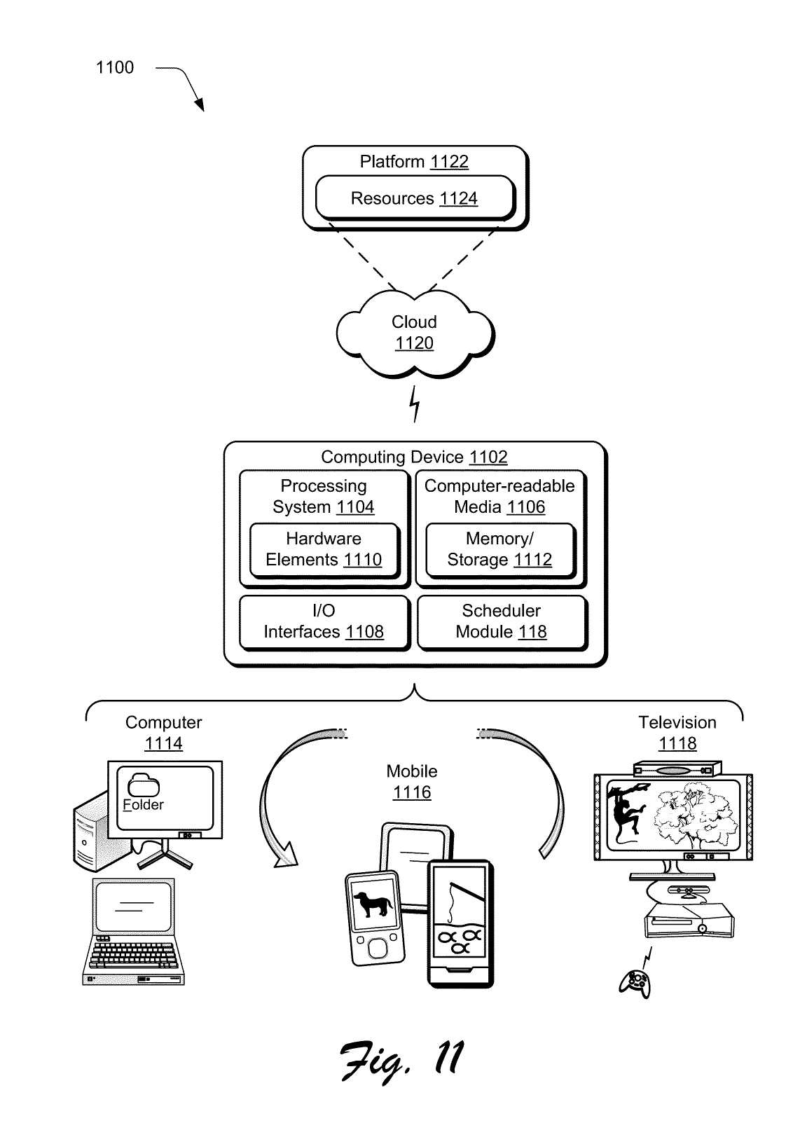

FIG. 1 is an illustration of an environment 100 in an example implementation that is operable to employ location aware reminder techniques described herein. The illustrated environment 100 includes a computing device 102. The computing device may be configured in a variety of ways. For example, a computing device may be configured as a computer that is capable of communicating over a network 104, such as a desktop computer, a mobile station, an entertainment appliance, a tablet, a set-top box communicatively coupled to a display device, a wireless phone, a game console, and any other device that is capable of receiving an indication of location. In the illustrated example, the computing device 102 is illustrated as assuming a mobile configuration through implementation using a housing 106 that is configured to be grasped by one or more hands 108, 110 of a user, e.g., as a mobile phone or tablet as further described in relation the FIG. 11.

Thus, the computing device 102 may range from full resource devices with substantial memory and processor resources (e.g., personal computers, game consoles) to a low-resource device with limited memory and/or processing resources (e.g., traditional set-top boxes, hand-held game consoles). Additionally, although a single computing device 102 is shown, the computing device 102 may be representative of a plurality of different devices, such as a client device in communication with a platform of a web service as shown in FIG. 11, a remote control and set-top box combination, an image capture device and a game console configured to capture gestures, and so on.

The computing device 102 is further illustrated as including an operating system 112. The operating system 112 is configured to abstract underlying functionality of the computing device 102 to one or more applications 114 that are executable on the computing device 102. For example, the operating system 112 may abstract processing, memory, network, and/or display 116 functionality of the computing device 102 such that applications may be written without knowing “how” this underlying functionality is implemented. An application 114, for instance, may provide data to the operating system 112 to be rendered and displayed by the display device 116 without understanding how this rendering will be performed. The operating system 112 may also represent a variety of other functionality, such as to manage a file system and user interface that is navigable by a user of the computing device 102.

The application 114 in this instance is illustrated as including a scheduler module 118 and a position determination module 120. Although illustrated as part of the application 114, it should be readily apparent that the functionality represented by these modules may be implemented in a variety of other ways, such as a stand-alone application, third-party plugin, as part of the operating system 112, as part of a web platform as shown in FIG. 11, and so forth.

The scheduler module 118 is representative of functionality to maintain a schedule of events for a user. The user, for instance, may serve as a meeting organizer and therefore create an event that describes criteria that pertains to the scheduled event, such as a subject (e.g., name of the event), location, start time, end time, may invite other attendees, a reminder, relative importance (e.g., high or low importance), and so forth. In another example, the user may accept an invitation from another meeting organizer which may include similar information. Regardless of how the event originated, the scheduler module 118 may maintain the events to assist a user in managing the schedule.

One technique involved in managing a user's schedule involves a reminder. Conventional reminders are output at a predefined amount of time before the event is scheduled to occur. This amount of time was conventionally set by an organizer of the event and was changeable manually by a user that was invited to participate with the event. Accordingly, these conventional techniques were static and inflexible.

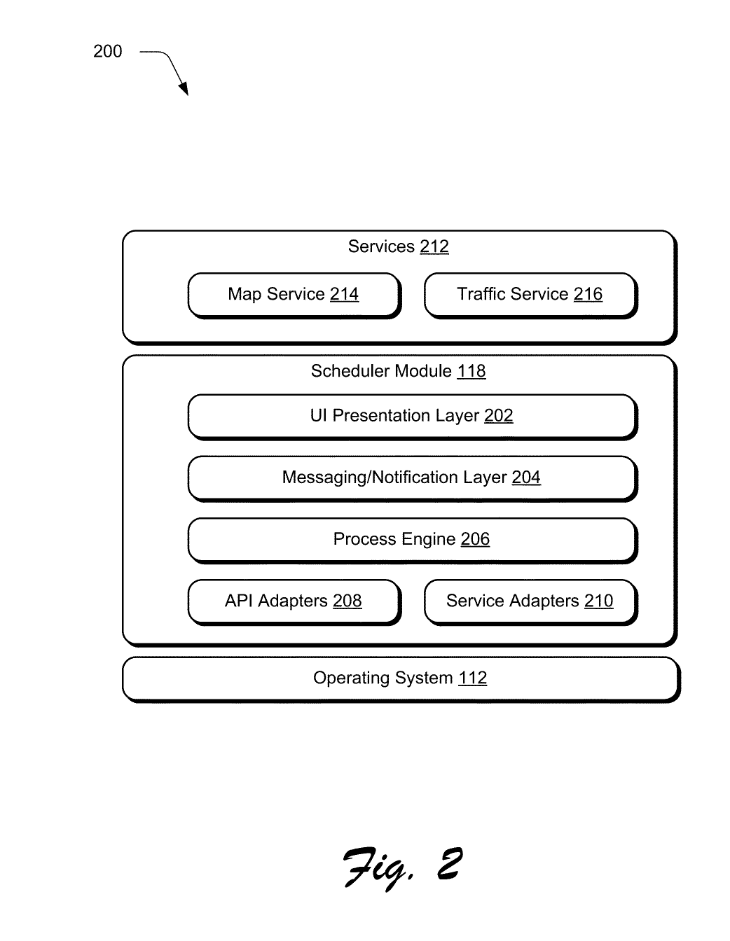

However, the scheduler module 118 in the illustrated instance may include functionality to dynamically determine the amount of time to be used to indicate when a reminder 122 is to be output. This determination may be based on a variety of different factors. For example, the scheduler module 118 may leverage the position determination module 120 to determine a current position of the computing device 102. This may be performed in a variety of ways, such as through position determination sensors 124 (e.g., GPS sensors, cellular triangulation, etc.) to determine a geographic position of the computing device 102. In another example, the geographic position of the computing device 102 may be performed through communication with one or more web services that are accessible via the network 104 as further described in relation to FIG. 2.

The scheduler module 118 may then compare this position with a geographic position associated with a scheduled event to determine a likely travel time between the current position and the position of the event. This time may then be used to compute when to output the reminder 122.

In the illustrated example, the reminder 122 is output as overlaid over tiles in start screen of a user interface, although other examples are also contemplated such as to include in a respective tile shown by the display device 116. The reminder 122 indicates a subject of the scheduled event, a location, an amount of time until the scheduled event is to occur, as well as a distance and travel time to a geographic location of the event. Thus, in this example the travel time (e.g., 20 minutes) is used at least in part with a predefined buffer time (e.g., 10 minutes which may be set as a user preference) to arrive at an amount of time that is to be set before the scheduled event for output of the reminder, e.g., 30 minutes in this example. Thus, the point at time at which the reminder 122 is output may be determined dynamically. Although determination of the point in time based at least on travel time was described, this determination may also be based on a variety of other factors, such as how the user is to access the event (e.g., in person or remotely), mode of travel to be used to physically attend the event, location of events that are scheduled to occur before the event, a change to a location at which the event is to occur, delays that are likely to affect travel time to the event (e.g., construction, accidents), and so on, further discussion of which may be found in relation to the following figures.

FIG. 2 depicts a system 200 in an example implementation in which a diagram that includes the scheduler module 118 of FIG. 1 is shown. The scheduler module 118 is shown in conjunction with the operating system 112 to leverage the functionality of the computing device 102 abstracted by the operating system 112 as previously described.

The scheduler module 118 is illustrated as including a UI presentation layer 202 that is representative of functionality to generate a user interface for rendering on the display device 116 of the computing device 102, such as to render the reminder 122 of FIG. 1. The scheduler module 118 is also illustrated as including a messaging/notification layer 204 that is representative of functionality involving messages and notifications, such as to communicate and manage meeting requests, output reminders, and so on.

The process engine 206 is representative of functionality to manage the schedule of a user. This may include generation of a scheduled event for inclusion in the calendar, resolution of conflicts, management of user preferences, maintenance of event related data, as well as determination of when to output reminders.

The scheduler module 118 is also illustrated as including API adapters 208 and service adapters 210. The API adapters 208 are configured to interact with APIs to obtain data related to a scheduled event, such as a calendar and/or location of the event. A variety of other examples are also contemplated, such as to determine a current geographic location by leveraging sensors of the computing device 102.

The service adapters 210 are configured to support access to one or more services 212, such as web services accessible via the network 104 of FIG. 1. A variety of different services may be accessed to locate data which may be used to dynamically generate the time at which the reminder is to be output. Examples of such services include a map service 214 and a traffic service 216. The map service 214 may be used to obtain a variety of data, such as geo-coordinates of a geographical location of the computing device 102 and/or a physical location at which the scheduled event is to occur. The map service 214 may also be used to compute a likely travel time between the locations, directions, a map showing the location, and so forth, and thus may support the functionality of the scheduler module 118.

The traffic service 216 may also be used to obtain a variety of different data that may be used as a basis to compute the amount of time. For example, the traffic service 216 may provide data regarding accidents, construction, and weather which may have an effect on a travel time between locations. A variety of other services 212 may also be accessed to provide data that may affect a computation of an amount of time that is to be used to schedule output of the reminder 122 of FIG. 1. An example of the operation of the scheduler module 118 to determine the point in time at which to output the reminder may be found in relation to the following figure.

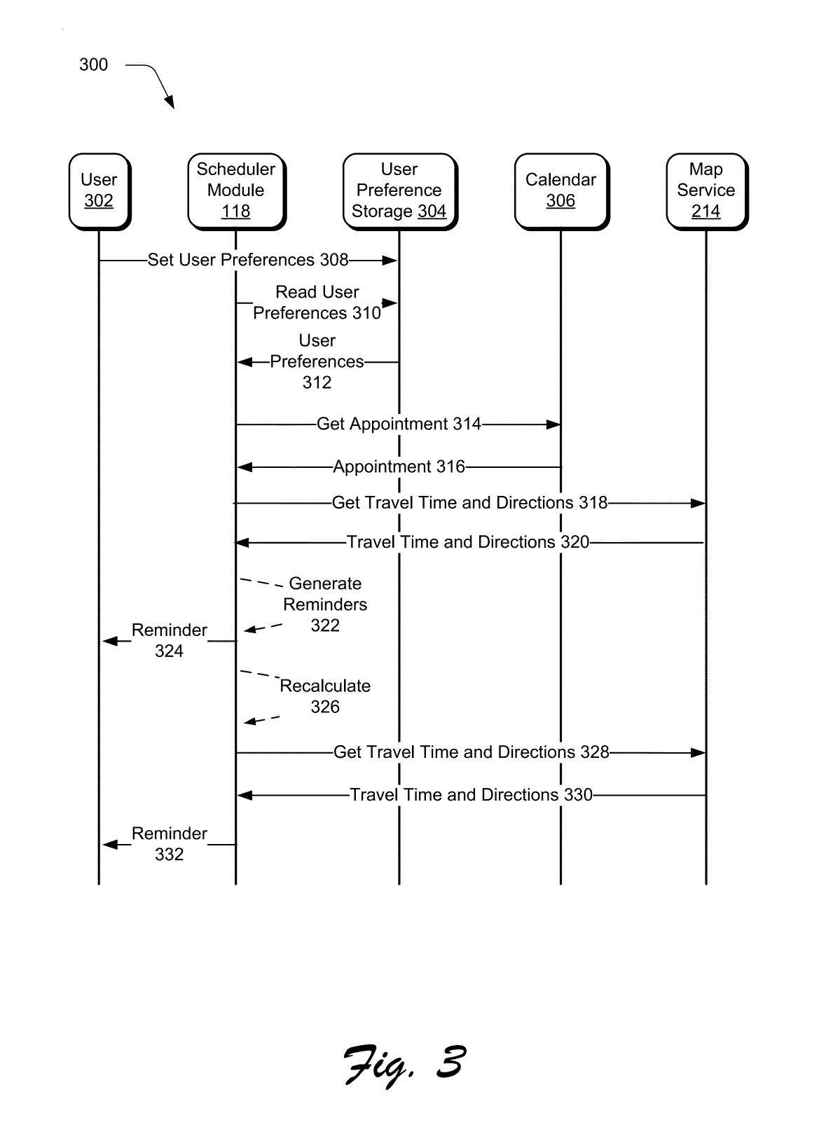

FIG. 3 depicts a sequence diagram 300 showing an example of determination of a point in time at which to output a reminder. The sequence diagram 300 includes representations of a user 302, the scheduler module 118, user preference storage 304, a calendar 306, and a map service 214.

In this example, the user 302 first sets user preferences 308 in the user preference storage 304. A variety of different user preferences may be set, such as a default buffer time to be used in conjunction with a travel time, predefined amounts of time to be used for different access techniques as a buffer (e.g., remote versus in person), a default geographic location for the user (e.g., home, office), a travel mode (e.g., car, walk, flight), and so forth. The scheduler module 118 may then read these user preferences 310 from user preference storage 304 for a particular user, e.g., illustrated as returned user preferences 312.

The scheduler module 118 is also illustrated as interacting with a stored calendar 306 to get an appointment 314, which is illustrated as returning data describing the appointment 316. The appointment 316 is an example of a scheduled event and therefore the data that is returned may describe a subject, date, time, or location of the appointment 316. The scheduler module 118 may then provide the location from the appointment to a map service to get travel time and directions 318 for the appointment. The map service 214, for instance, may resolve a common name, address, and so on from the appointment to calculate a travel time between a likely current location of the computing device 102 of FIG. 1 (and consequently the user 302) and a location associated with the appointment. The map service 214 may also calculate directions between the locations and return the travel time and directions 320 back to the scheduler module 118. Thus, in this example the scheduler module 118 may determine the travel time through communication with the map service 214 that performs the calculation, although other examples are also contemplated.

The scheduler module 118 may then use the travel time and directions 320 to determine a point in time at which to generate and output the reminder 322, 324, an example of which is shown as the reminder 122 in FIG. 1. In this way, the reminder may be generated dynamically to take into account a user's mode of access to the event (e.g., in person as opposed to remote access) and geographic relationship to a location associated with the event for in person access.

The reminder may also be recalculated 326 based on changing factors that are used to determine the point in time at which to output the reminder. A location of the event, for instance, may be changed and therefore the scheduler module 118 may get a new travel time and directions 328 from the map service 214. The map service 214 may then return the travel time and directions 330 that were computed for the new location, which is used by the scheduler module 118 to generate another reminder 332 for output to the user 302. A variety of other factors may also be used to recalculate 326 the reminder, such as a change in a geographic location of the user 302 (e.g., as the user moves closer to the location of the appointment), performed at predefined intervals of time for subsequent reminders, and so forth. Although determination of a travel time by the scheduler module 118 was described in this example, a variety of other factors may also be leveraged by the scheduler module 118 to determine a point in time at which to output the reminder, an example of which may be found in relation to the following figure.

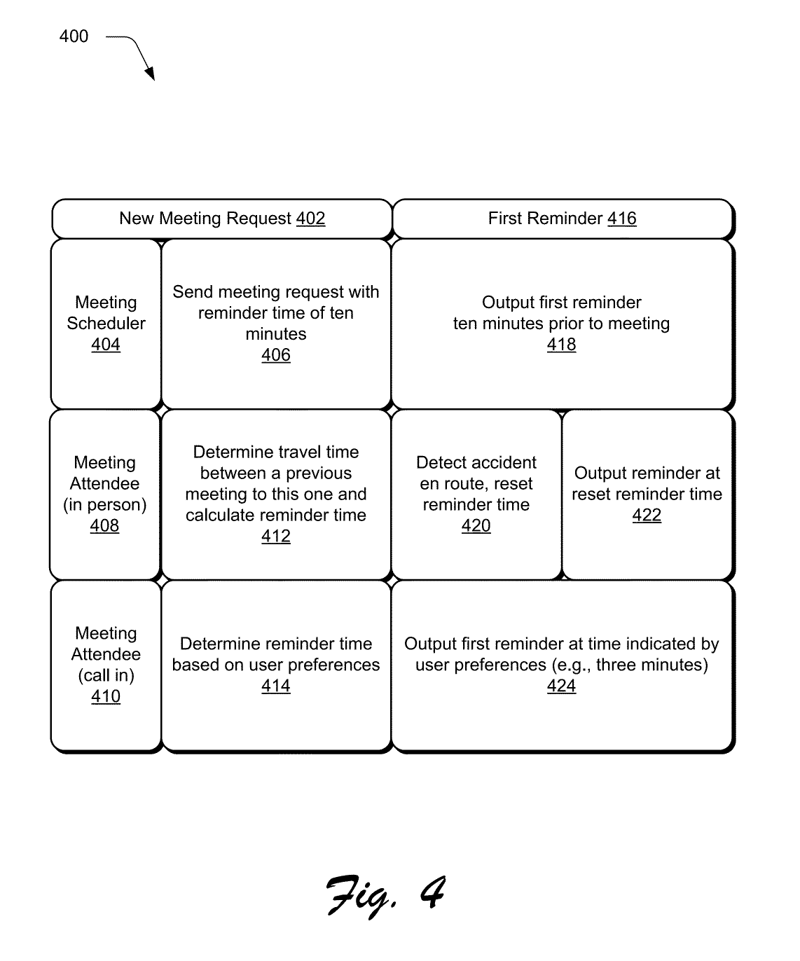

FIG. 4 depicts an example of a workflow 400 that is used to output different reminders for different users that are to access a scheduled event. In this example, a new meeting request 402 is originated by a meeting scheduler 404. The meeting request is set by the meeting scheduler 404 to have a reminder time of ten minutes 406, and is sent to other meeting attendees. Examples of other meeting attendees are illustrated as a meeting attendee 408 that is to attend in person and a meeting attendee 410 that is to access the event remotely, e.g., by calling in, logging into a website, through online meeting application, video conferencing, and so forth.

For the meeting attendee 408 that is going to attend in person, a scheduler module determines a travel time between a location of a previous meeting and a location of the new meeting request 402 to calculate a reminder time 412, e.g., a point of time at which to output the reminder. In another example, this may be determined based on a default location, e.g., home, office, and so forth.

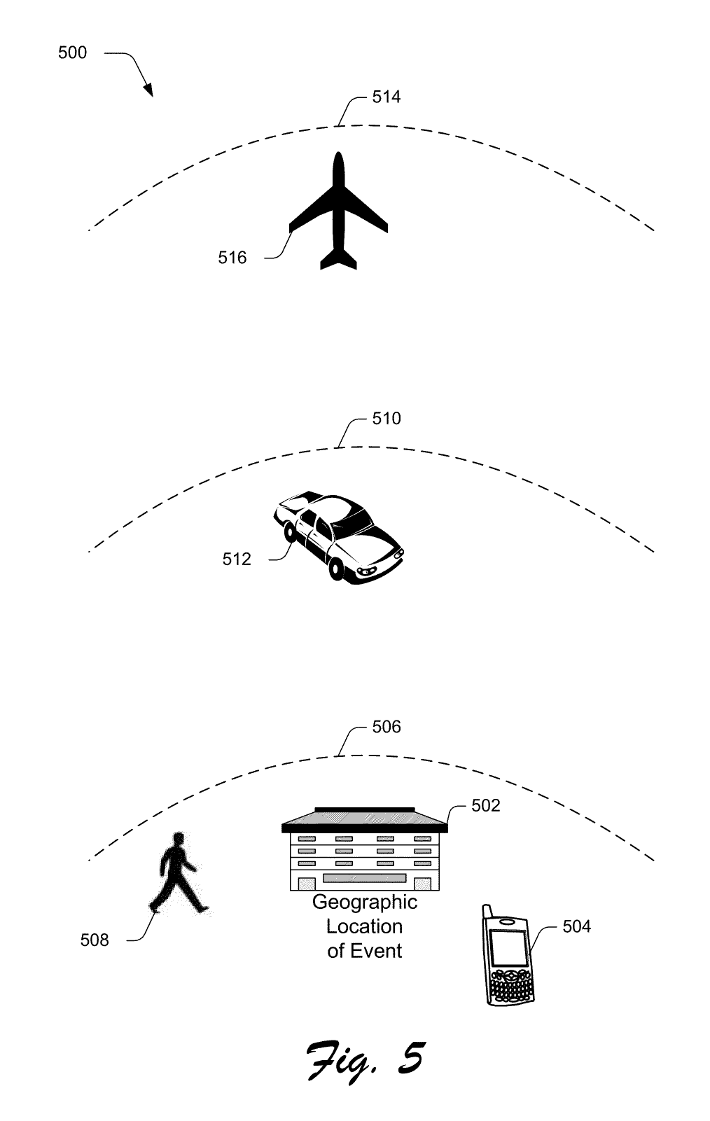

For the meeting attendee 410 that is to access the event remotely, a reminder time is determined based on user preferences 414. For example, the meeting attendee 410 may plan to “call in” to perform a teleconference and therefore specify a buffer time that is preferred by the attendee to prepare for the meeting. This buffer time may be stored as part of the user preferences as previously described in relation to FIG. 3. A variety of different buffer times may be specified as part of the user preferences, such as based on mode of transportation (e.g., motorized, un-motorized, and so on as shown in FIG. 5), type of access (e.g., call in, log in, physical presence), and so forth as described in greater detail in relation to the flow diagrams.

A first reminder 416 may then be output for the meeting scheduler 404, meeting attendee 408 that is to physically attend the meeting, and the meeting attendee 410 that is to attend the meeting remotely. For the meeting scheduler 404, the first reminder 416 is output ten minutes prior to the meeting 418 as specified.

For the meeting attendee 408 that is to attend in person, an accident is detected en route in this example, so the reminder time is reset 420 to account for the delay. The scheduler module 118, for instance, may communicate with the traffic service 216 as previously described and adjust the reminder time accordingly based on the delay indicated by the service The reminder is then output at the reset reminder time 422, such as earlier to give the meeting attendee 408 additional time to travel to a location of the meeting. Thus, the amount of time may dynamically address changing conditions that could affect the user's ability to physically attend the event.

For the meeting attendee 410 that is to access the meeting remotely, the first reminder 416 is output at a time indicated by user preferences 424, such as three minutes to allow the user to prepare before “calling in” to the meeting. In this way, the first reminder 416 may be output at different points in time for each of the attendees to account for how the attendees are to access the meeting. A variety of other examples are also contemplated of factors that may be used to calculate when to output the reminder, examples of which may be found in relation to the following figure.

FIG. 5 depicts a system 500 that is configured to employ the scheduler module to address how a user is to access a scheduled event. As previously described, a user may access a scheduled event 502 in a variety of ways, such as to attend remotely as illustrated by the mobile phone 504 or in person. Accordingly, the scheduler module 118 may take into account these different types of access.

Further, the scheduler module 118 may also take into account a mode of travel that may be used to physically bring the user to the geographic location of the event 502 For example, the mode of travel may distinguish between non-motorized (e.g., walking, biking) and motorized modes of travel. This determination of which mode a user is likely to use may be based on distance, availability of different modes of travel to cover the distance, may involve configuration at an application level as well as event level, and so on.

For example, the user may be located at a distance 506 that is suitable for walking 508 to the geographic location of the event 502 and accordingly the amount of time calculated by the scheduler module 118 may take this into account. In another example, the user may be located at a distance 510 that is indicative of motorized travel 512 (e.g., car, bus, rail, public transit) and therefore use this as part of the calculation. For example, the scheduler module 118 may access a service including public transit data to determine a travel time using public transit. In a further example, difference between modes of motorized travel may be used, such as a distance 514 that is indicative of air travel 516.

Further, user preferences may be defined to take into account these various modes of travel. For example, different buffer times may be set for different modes of travel, such as to provide sufficient time to board a flight, and so on. Additionally, the user preferences may be defined to employ thresholds that may be used to even avoid output of the reminder, avoid calculation of a travel time when past a threshold distance or amount of travel time (e.g., to use the default amount of time without including travel time), and so on. In this way, the user may manage how and when the reminders are output, such as to reduce clutter and interruptions caused by undesired reminders.

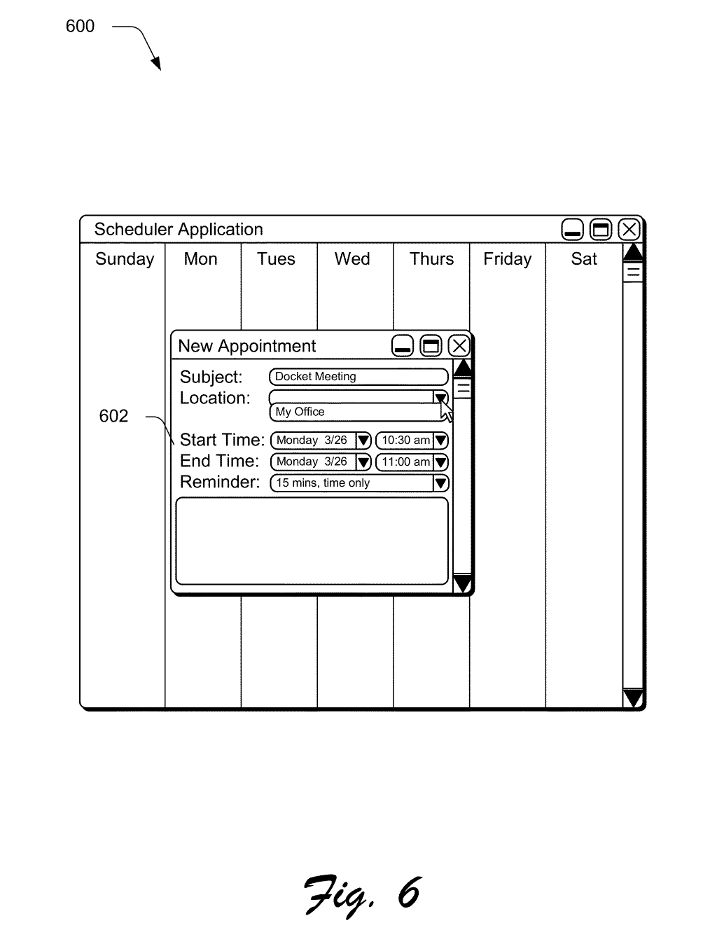

FIG. 6 depicts an example of a user interface 600 usable to schedule an event. In this example, the user interface 600 is illustrated as outputting new appointment functionality such that an organizer can schedule an event for inclusion in a calendar. In this example, a user interacts with the new appointment to specify a location for the scheduled event, which is shown as including a default location of “my office” in this example. Geographic location identifying data (e.g., geo-coordinates) may be associated with the location that is suitable for determining a travel time to the location. Other examples are also contemplated, such as the include functionality as part of the scheduler module 118 and/or service (e.g., map service) to resolve a common name (e.g., Redmond Campus, Studio B) to specific geographic coordinates.

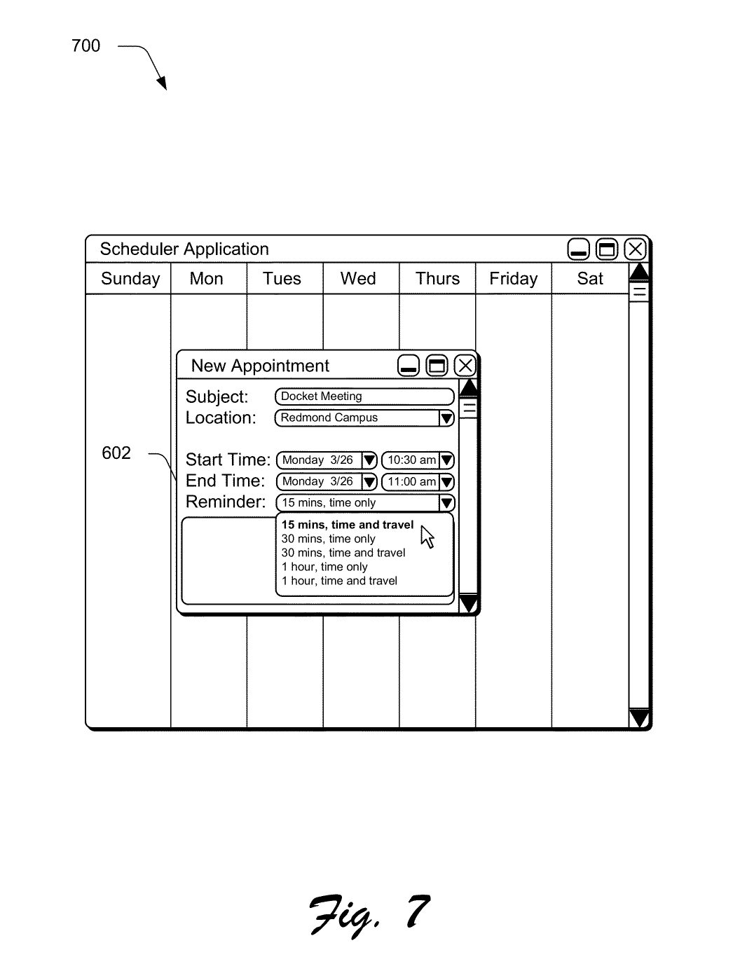

FIG. 7 depicts an example of a user interface 700 usable to schedule whether to use travel time as part of a reminder for the event of FIG. 6. This example continues from the user interface 600 of FIG. 6. In this instance, however, the new appointment is illustrated as providing functionality for the organizer to specify a time to be used to output a reminder for the event. In this instance, the user is given options to select a set amount of time (e.g., “15 mins, time only”) or select a set amount of time and travel time (e.g., “15 mins, time and travel). Thus, the options in this example allow the user to specify the buffer time as well as to utilize a travel time. A variety of other examples are also contemplated (e.g., use of a check box indicating whether to consider travel time), further discussion of which may be found in relation to the following procedures.

Example Procedures

The following discussion describes reminder techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-7.

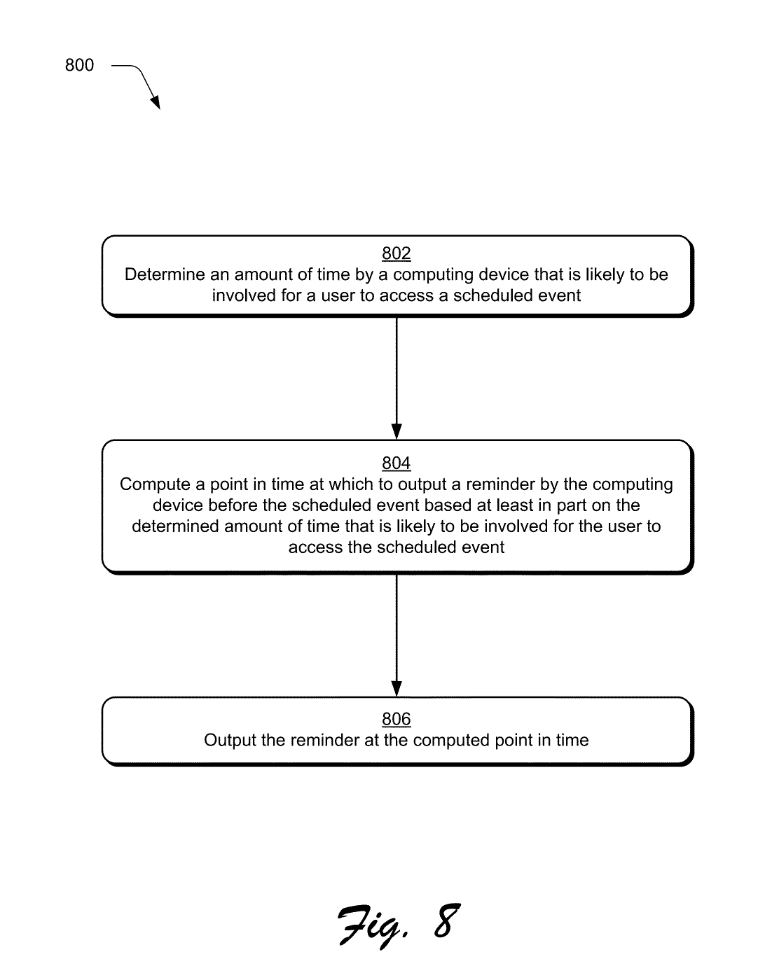

FIG. 8 depicts a procedure 800 in an example implementation in which a point at time at which to output a reminder is determined based on user access. An amount of time is determined by a computing device that is likely to be involved for a user to access a scheduled event (block 802). The scheduler module 118, for instance, may determine “how” a user is specified to access the scheduled event, such as remotely via a network or physically in person. Further, the determination may be based on a mode of travel, such as motorized or un-motorized, and even mode of travel involved with the motorized access. Further, this determination may be performed by the computing device 102 itself (e.g., using a GPS or other location determining functionality), through communication with a service, and so on.

Further, the determination of a likely geographic location of the computing device 102 may be performed in a variety of ways. This may be performed using sensors of the computing device 102 or through communication with a service as previously described. Additionally, this determination may be based on “knowledge” of other scheduled events, such as a geographic location of another event that is scheduled before the event in question.

A point in time at which to output a reminder by the computing device before the scheduled event is computed based at least in part on the determined amount of time that is likely to be involved for the user to access the scheduled event (block 804). The point in time, for instance, may be computed based on a start time of the event, a travel time determined above, and a buffer time set by the user using user preferences or automatically by the computing device 102. In this way, the scheduler module 118 may determine “when” to output the reminder.

The reminder is then output at the computed point in time (block 806). This may include display in a user interface, haptic response, audio output, and so on. In this way, the reminder may be dynamically computed based on how a user is to access the event.

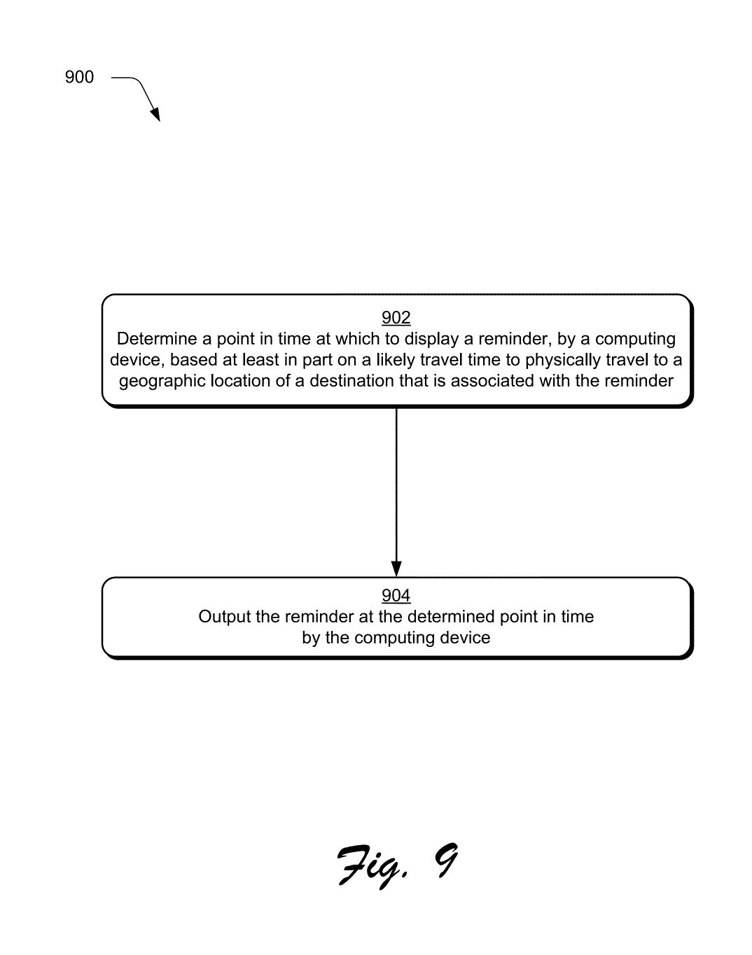

FIG. 9 depicts a procedure 900 in an example implementation in which a point at time at which to display a reminder is determined at least in part on a travel time to a geographic location. A point in time is determined at which to display a reminder, by a computing device, based at least in part on a likely travel time to physically travel to a geographic location of a destination associated with the reminder (block 902). The likely travel time may be computed based on a variety of factors, such as distance and mode of travel, delays that may be encountered (e.g., construction, traffic, weather), and so forth. As before, this may be computed by the computing device itself, may leverage one or more web services, and so on. The reminder is then output at the determined point in time by the computing device (block 904). As before, the output may be performed using a variety of different output techniques.

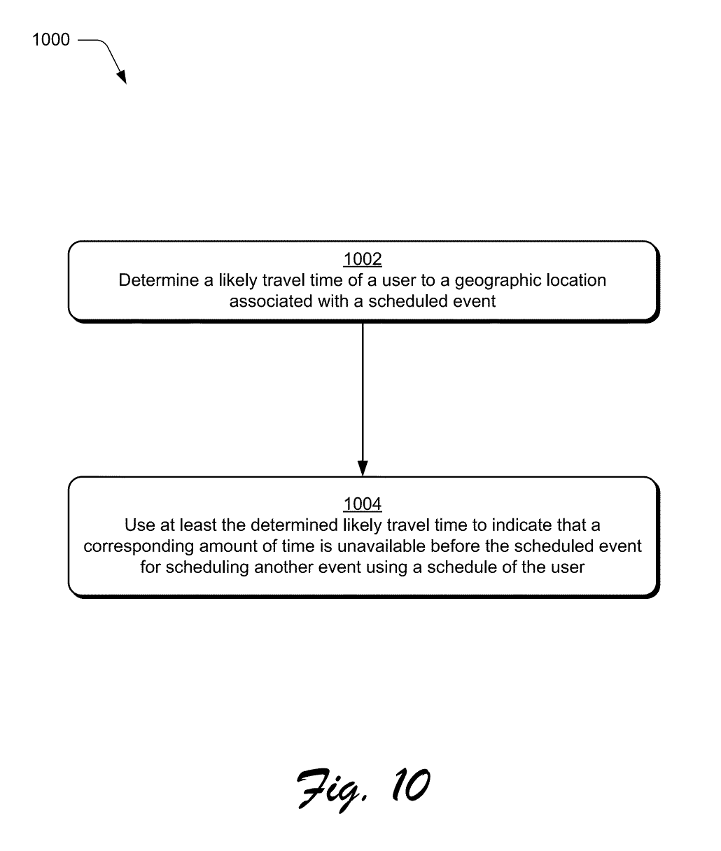

FIG. 10 depicts a procedure in an example implementation in which an amount of time that is likely to be used to travel to a scheduled event is indicated as unavailable on a user's calendar. A determination is made as to likely travel time of a user to a geographic location associated with a scheduled event (block 1002). At least the determined likely travel time is used to indicate that a corresponding amount of time is unavailable before the scheduled event for scheduling another event using a schedule of the user (block 1004).

This determination may be performed as previously described in relation to the reminder. Further, this determination may leverage the reminder for both purposes, such as to as be used for the reminder as well as to indicate that the amount of time is unavailable on the user's schedule. This may be performed in a variety of ways, such as indicating that a corresponding period of time is “blocked out,” indicated as potentially conflicting responsive to receipt of a meeting request, and so forth. A variety of other examples are also contemplated, such as to use a similar determination to block an amount of time after the scheduled event such that a user may travel back to a default location, e.g., an office.

Example System and Device

FIG. 11 illustrates an example system generally at 1100 that includes an example computing device 1102 that is representative of one or more computing systems and/or devices that may implement the various techniques described herein. The computing device 1102 may be, for example, a server of a service provider, a device associated with a client (e.g., a client device), an on-chip system, and/or any other suitable computing device or computing system.

The example computing device 1102 as illustrated includes a processing system 1104, one or more computer-readable media 1106, and one or more I/O interface 1108 that are communicatively coupled, one to another. Although not shown, the computing device 1102 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including hardware element 1110 that may be configured as processors, functional blocks, and so forth. This may include implementation in hardware as an application specific integrated circuit or other logic device formed using one or more semiconductors. The hardware elements 1110 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1106 is illustrated as including memory/storage 1112. The memory/storage 1112 represents memory/storage capacity associated with one or more computer-readable media. The memory/storage component 1112 may include volatile media (such as random access memory (RAM)) and/or nonvolatile media (such as read only memory (ROM), Flash memory, optical disks, magnetic disks, and so forth). The memory/storage component 1112 may include fixed media (e.g., RAM, ROM, a fixed hard drive, and so on) as well as removable media (e.g., Flash memory, a removable hard drive, an optical disc, and so forth). The computer-readable media 1106 may be configured in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1102. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1102, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1110. The computing device 1102 may be configured to implement particular instructions and/or functions corresponding to the software and/or hardware modules. Accordingly, implementation of a module that is executable by the computing device 1102 as software may be achieved at least partially in hardware, e.g., through use of computer-readable storage media and/or hardware elements 1110 of the processing system 1104. The instructions and/or functions may be executable/operable by one or more articles of manufacture (for example, one or more computing devices 1102 and/or processing systems 1104) to implement techniques, modules, and examples described herein.

As further illustrated in FIG. 11, the example system 1100 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1100, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. For example, functionality may be distributed through the environment, e.g., the scheduler module 118 may be implemented as part of a web platform, implemented locally on the computing device 1102, and so on. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1102 may assume a variety of different configurations, such as for computer 1114, mobile 1116, and television 1118 uses. Each of these configurations includes devices that may have generally different constructs and capabilities, and thus the computing device 1102 may be configured according to one or more of the different device classes. For instance, the computing device 1102 may be implemented as the computer 1114 class of a device that includes a personal computer, desktop computer, a multi-screen computer, laptop computer, netbook, and so on.

The computing device 1102 may also be implemented as the mobile 1116 class of device that includes mobile devices, such as a mobile phone, portable music player, portable gaming device, a tablet computer, a multi-screen computer, and so on. The computing device 1102 may also be implemented as the television 1118 class of device that includes devices having or connected to generally larger screens in casual viewing environments. These devices include televisions, set-top boxes, gaming consoles, devices capable of detecting a geographic location of the device, and so on.

The techniques described herein may be supported by these various configurations of the computing device 1102 and are not limited to the specific examples of the techniques described herein. This functionality may also be implemented all or in part through use of a distributed system, such as over a “cloud” 1120 via a platform 1122 as described below.

The cloud 1120 includes and/or is representative of a platform 1122 for resources 1124. The platform 1122 abstracts underlying functionality of hardware (e.g., servers) and software resources of the cloud 1120. The resources 1124 may include applications and/or data that can be utilized while computer processing is executed on servers that are remote from the computing device 1102. Resources 1124 can also include services provided over the Internet and/or through a subscriber network, such as a cellular or Wi-Fi network.

The platform 1122 may abstract resources and functions to connect the computing device 1102 with other computing devices. The platform 1122 may also serve to abstract scaling of resources to provide a corresponding level of scale to encountered demand for the resources 1124 that are implemented via the platform 1122. Accordingly, in an interconnected device embodiment, implementation of functionality described herein may be distributed throughout the system 1100. For example, the functionality may be implemented in part on the computing device 1102 as well as via the platform 1122 that abstracts the functionality of the cloud 1120.

### CONCLUSION

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A method comprising:
determining an amount of time that is likely to be involved for a user to access a scheduled event; and
computing a point in time at which to output a reminder by the computing device before the scheduled event based at least in part on the determined amount of time that is likely to be involved for the user to access the scheduled event.

2. A method as described in claim 1, wherein the point is time is calculated based on an indication of how the user is to access the scheduled event.

3. A method as described in claim 2, wherein the indication specifies whether the user is to access the scheduled event physically in person or remotely via a network.

4. A method as described in claim 1, wherein the point is time is calculated based on a travel time that is likely between a likely geographic location of a user associated with the reminder and the geographic location of the destination.

5. A method as described in claim 4, wherein the travel time is based at least in part on a mode of travel that is likely to be utilized by the user.

6. A method as described in claim 4, wherein the likely geographic location is determined based at least in part through communication of the computing device with a service via a network.

7. A method as described in claim 4, wherein the likely geographic location is determined based at least in part on a geographic location of another scheduled event that is scheduled to occur before the scheduled event.

8. A method as described in claim 4, wherein the determining and the computing are repeated at different points in time to update the point in time of the reminder.

9. A method as described in claim 4, wherein the different points in time occur at predefined intervals, responsive to a determination of movement of the computing device to a different geographic location, or responsive to a determination of a change in the geographic location of the destination of the scheduled event.

10. A method as described in claim 1, further comprising outputting the reminder at the computed point in time.

11. A method comprising:
determining a point in time at which to display a reminder, by a computing device, based at least in part on a likely travel time to physically travel to a geographic location of a destination that is associated with the reminder; and
outputting the reminder at the determined point in time by the computing device.

12. A method as described in claim 11, wherein the likely travel time is based at least in part on a mode of travel that is likely to be used by the user to physically travel to the geographic location.

13. A method as described in claim 11, wherein the mode of travel includes whether the user is likely to use motorized or un-motorized travel.

14. A method as described in claim 11, wherein the likely travel time is based at least in part on a current geographic location of the computing device.

15. A method as described in claim 11, wherein the likely travel time is based at least in part on whether there are delays indicated along a route to be traveled.

16. A method comprising:
determining a likely travel time of a user to a geographic location associated with a scheduled event; and
using at least the determined likely travel time to indicate that a corresponding amount of time is unavailable before the scheduled event for scheduling another event in a schedule of the user.

17. A method as described in claim 16, wherein the corresponding amount of time is indicated as unavailable for scheduling the other event before the scheduled event by outputting an indication of the scheduling of the scheduled event and corresponding likely travel time.

18. A method as described in claim 16, wherein the likely travel time is based at least in part on a likely physical location of the user prior to the scheduled event.

19. A method as described in claim 16, wherein the likely travel time is based at least in part on a mode of travel that is likely to be used by the user to physically travel to the geographic location of the scheduled event.

20. A method as described in claim 16, wherein the determining is performed dynamically at different points in time, in which the different points of time are defined using predefined intervals, responsive to a determination of movement of the computing device to a different geographic location, or responsive to a determination of a change in the geographic location of the destination of the scheduled event.
